(19) United States
(12) Patent Application Publication
(10) Pub. No.: US 2005/0144242 A1
(43) Pub. Date: Jun. 30, 2005

(54) Caching in an electronic messaging system

(76) Inventors: Justin Marston, Richmond (GB); Andrew Hatch, Hurworth-on-Tees (GB)

Correspondence Address: FENWICK & WEST LLP, SILICON VALLEY CENTER, 801 CALIFORNIA STREET, MOUNTAIN VIEW, CA, 94041, US

(21) Appl. No.: 10/977,354

(22) Filed: Oct. 28, 2004

Related U.S. Application Data
(60) Provisional application No. 60/517,230, filed on Oct. 31, 2003.
(60) Provisional application No. 60/527,214, filed on Dec. 4, 2003.
(60) Provisional application No. 60/570,848, filed on May 12, 2004.
(60) Provisional application No. 60/570,861, filed on May 12, 2004.
(60) Provisional application No. 60/612,436, filed on Sep. 22, 2004.
(60) Provisional application No. 60/612,552, filed on Sep. 22, 2004.

(51) Int. Cl. G06F 15/16; G06F 17/30

(52) U.S. Cl. 709/206; 707/10

(57) ABSTRACT

A messaging server (112, 612) stores messages exchanged using a messaging system. Messages, and components of messages, are cached (120, 618) closer to the messaging clients (116, 616). Messaging client (116, 616) requests for messages are served from the cache (120, 618) rather than from the messaging server (112, 612). The messages can be secured using security information (920) stored at the messaging server (112, 612). The messaging server (112, 612) sends the security information directly to the messaging clients (116, 616).

### CROSS-REFERENCE TO RELATED APPLICATIONS

This application claims the benefit of U.S. Provisional Application Nos. 60/517,230, filed Oct. 31, 2003, 60/527,214, filed Dec. 4, 2003, 60/570,848, filed May 12, 2004, 60/570,861, filed May 12, 2004, 60/612,436, filed Sep. 22, 2004, and 60/612,552, filed Sep. 22, 2004, all of which are hereby incorporated by reference herein. This application is related to U.S. Utility Application No. 10/789,461, filed Feb. 26, 2004, which is hereby incorporated by reference herein.

### BACKGROUND OF THE INVENTION

1. Field of the Invention

This invention pertains in general to electronic messaging and in particular to delivery and caching of secure messages via a network such as the Internet.

2. Description of the Related Art

Email is an extremely important communications tool in today's business environment. To a large extent, email has replaced regular mail, telephones, and facsimiles as the preferred method of communication. A typical person in a business or other enterprise can send and receive dozens or hundreds of emails a day. Moreover, the volume of email traffic continues to increase year-after-year.

An enterprise thus needs to manage a large, and increasing, volume of email. Most enterprises utilize dedicated email servers to process their email. However, most email servers do not scale to support large numbers of end-users and/or heavy email traffic. Large enterprises having many end-users must therefore have multiple email servers, with each server serving a subset of the total email users. For example, a very large company might have more than 1000 separate email servers.

Administering multiple email servers is difficult and costly. Each email server has parameters and policies that must be independently managed. Furthermore, each server also acts as the primary store for its end-users' content, and thus must be backed up regularly. Moreover, it is difficult to perform functions such as auditing and searching because the email content is distributed over multiple locations.

Centralized data centers have been used to overcome some of the difficulties inherent in managing multiple email servers. In one centralized system, a “server farm” is utilized to run multiple instances of email servers under a single management system. In another centralized system, a scalable back end is added to the email server, thereby allowing the server to support a greater number of users than conventional servers.

The centralized solutions still have undesirable characteristics. A centralized server for an enterprise is likely to be remote from a large subset of the end-users. Since every email sent or received by an end-user must pass over the connection between the end-user's email client and the central server, the network connection utilized by the central server must support high bandwidth.

Another undesirable characteristic of centralized mail servers is the high latency for interactions with the email clients. The most common communications protocols utilized between email servers and email clients utilized by enterprises are not optimized for use with wide area networks such as the Internet. When a central server is located on a wide area network, such as when the server is supporting an enterprise having multiple geographic locations, the speed of individual email transactions can be quite slow. This slowness detracts from the end-user experience and may hamper the efficiency of the enterprise.

Therefore, there is a need for an electronic messaging system that scales well to support a large number of end-users yet does not suffer from the drawbacks mentioned above.

### BRIEF SUMMARY OF THE INVENTION

The above need is met by storing messages at a messaging server (112, 612) and caching messages, and components of messages, close to messaging clients (116, 616). Messaging client (116, 616) requests for messages are served-from the cache (120, 618) rather than from the messaging server (112, 612). The messages can be secured using security information (920) stored at the messaging server (112, 612). The messaging server (112, 612) sends the security information directly to the messaging clients (116, 616).

### BRIEF DESCRIPTION OF THE DRAWINGS

FIG. 1 is a high-level block diagram of an environment including an embodiment of a caching messaging system.

FIG. 2 is a high-level block diagram showing a computer system for acting as a messaging server, proxy server, and/or messaging client according to one embodiment.

FIG. 3 is a high-level block diagram illustrating modules within the messaging server according to one embodiment.

FIG. 4 is a high-level block diagram illustrating modules within the proxy server according to one embodiment.

FIG. 5 is a flow diagram illustrating transactions between a messaging client, a proxy server, and a messaging server according to one embodiment.

FIG. 6 is a high-level block diagram illustrating an environment including an embodiment of a relational messaging system using caching.

FIG. 7 is a block diagram illustrating a representation of a message exchanged according to an embodiment of the relational messaging system.

FIG. 8 illustrates a set of interactions that explain the relationship among messages, current submessages, and history submessages.

FIG. 9 is a high-level block diagram illustrating modules within the messaging server according to one embodiment of the relational messaging system.

FIG. 10 is a high-level block diagram illustrating modules within the proxy server according to one embodiment of the relational messaging system.

FIG. 11 is a high-level block diagram illustrating modules within the messaging client according to one embodiment of the relational messaging system.

FIG. 12 is a flow diagram illustrating transactions between a messaging client, a proxy server, and a messaging server according to one embodiment of the relational messaging system.

FIG. 13 is a flow diagram illustrating transactions between a messaging client, a proxy server, and a messaging server according to one embodiment of the relational messaging system.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION OF THE PREFERRED EMBODIMENTS

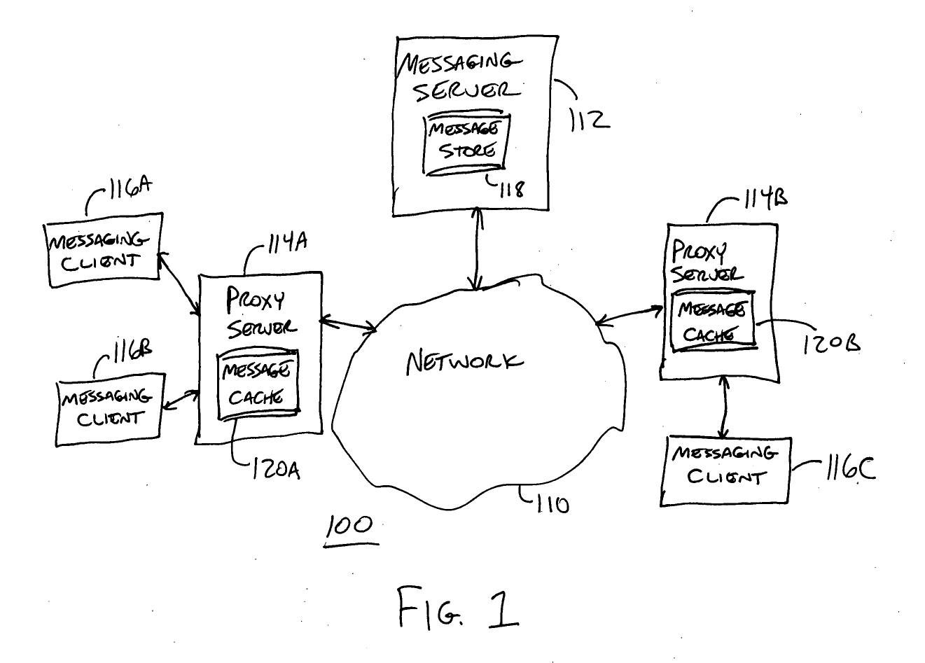

FIG. 1 is a high-level block diagram of an environment 100 including an embodiment of a caching messaging system. In one embodiment, the messaging system is utilized by an enterprise to manage messages received by end-users associated with the enterprise. For example, a company can use the messaging system to manage messages received by employees of the company. Likewise, an Internet Service Provider (ISP) can use the messaging system to manage messages received by end-users of the ISP.

The environment 100 includes a network 110 connected to a messaging server 112 and two proxy servers 114. In the illustrated embodiment, one proxy server 114A is connected to two messaging clients 116A, 116B, and the other proxy server 114B is connected to one messaging client 116C. Only two proxy servers 114 and three messaging clients 116 are shown in FIG. 1 for purposes of clarity, but those of skill in the art will recognize that embodiments of the messaging system can have many proxy servers 114 and or messaging clients 116.

FIG. 1 and the other figures use like reference numerals to identify like elements. A letter after a reference numeral, such as “114A,” indicates that the text refers specifically to the element having that particular reference numeral. A reference numeral in the text without a following letter, such as “100,” refers to any or all of the elements in the figures bearing that reference numeral (e.g. “100” in the text refers to reference numerals “100A,” “100B,” and/or “100C” in the figures).

In general, end-users of messaging clients 116 use the messaging system to exchange messages with other end-users. As used herein, the term “message” refers to a data communication sent by one end-user to one or more end-users of the messaging system. In one embodiment, the messages are emails. In another embodiment, the messages are Short Message Service (SMS) messages, Instant Messages (IMs), Multi-Media Message (MMS) and/or other types of messages. The term “message” can also include media files, such as discrete and/or streaming audio and/or video, still images, etc. In one embodiment, described below, a message is a container having relational links.

In one embodiment, a message sent by an end-user includes a message body that contains text, images, audio and/or other types of data. A message can also include one or more attachments, which are typically data files associated with the message that a receiving end-user can separate from the message body. An end-user can perform various actions on messages, including composing, sending, reading, replying to, and forwarding.

The network 110 enables data communication between and among the entities connected to the network and allows the entities to exchange messages. In one embodiment, the network 100 is the Internet. The network 110 can also utilize dedicated or private communications links that are not necessarily part of the Internet. In one embodiment, the network 110 uses standard communications technologies and/or protocols. Thus, the network 110 can include links using technologies such as Ethernet, 802.11, integrated services digital network (ISDN), digital subscriber line (DSL), asynchronous transfer mode (ATM), etc. Similarly, the networking protocols used on the network 110 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), as were the various messaging protocols described below. The data exchanged over the network 110 can be represented using technologies and/or formats including the hypertext markup language (HTML), the extensible markup language (XML), etc. In addition, all or some of links can be encrypted using conventional encryption technologies such as the secure sockets layer (SSL), Secure HTTP and/or virtual private networks (VPNs). In another embodiment, the entities can use custom and/or dedicated data communications technologies instead of, or in addition to, the ones described above.

In one embodiment, the messaging server 112 acts as a central repository for messages received by the end-users of the messaging system. The messaging server 112 can communicate with the messaging clients 116 and proxy servers 114 via the network 110. In addition, the messaging server 112 can communicate with messaging servers and clients outside of the enterprise messaging system via the network 110. In one embodiment, the messaging server 112 receives messages sent from outside the enterprise to end-users within the enterprise and messages sent by end-users within the enterprise to other end-users within the enterprise. In one embodiment, the messaging server 112 provides interfaces that allow other entities in the enterprise, such as the proxy servers 114 and/or messaging clients 116 to retrieve messages from it.

In one embodiment, the messaging server 112 includes a message store database 118 that stores a copy of each message exchanged using the messaging system, or at least a designated subset of the messages exchanged using the system. Each message in the database 118 is identified by a unique message identification (MID). In one embodiment, the MID generally corresponds to the “Message-ID” specified in RFC 2111.

As used herein, the term “database” refers to an information store and does not imply that the data within the database are organized in a particular structure beyond that described herein. Although only a single database 118 is illustrated in FIG. 1, embodiments of the messaging server 112 can utilize multiple databases. In addition, the database 118 can be local or remote to the messaging server 112. The database 118 is illustrated as being local to the messaging server 112 for purposes of clarity.

A proxy server 114 communicates with the messaging server 112 via the network 110. In addition, the proxy server 114 communicates with one or more messaging clients 116 via the network 110. Although FIG. 1 shows a direct connection between the proxy server 114 and the messaging clients 116, those of skill in the art will recognize that this connection can be made over the network 110. In one embodiment, the proxy server 114 is close to its messaging client 116 in the network sense. The closeness means that the proxy server 114 can usually communicate with the messaging clients 116 at a higher bandwidth and/or lower latency than could the messaging server 112.

In one embodiment, the proxy server 114 acts as a messaging server with respect to the messaging clients 116 and acts as a messaging client with respect to the messaging server 112. Accordingly, the proxy server 114 can exchange messages with the messaging clients 116 and with the messaging server 112.

In one embodiment, the proxy server 114 includes a message cache 120 for storing messages passing through the proxy server 114. In general, the message cache 120 stores local copies of messages held in the message store database 118. When the proxy server 114 receives a request for a message from a messaging client 116, the proxy server 114 seeks to fulfill the request using a copy of the message stored in the message cache 120. This arrangement decreases the latency of providing the message to the messaging client, and reduces both the processing and bandwidth requirements for the messaging server 112.

The messaging client 116 is a device utilized by an end-user to compose, view, and perform other tasks with the messages. The messaging client 116 is connected to the network 110 and can communicate with the proxy server 114, messaging server 112, and/or other entities coupled to the network. In one embodiment, the messaging client 116 is a computer system executing standard messaging software, such as MICROSOFT OUTLOOK or LOTUS NOTES. Depending upon the embodiment, some or all of the clients 116 can be other types of electronic devices, such as personal digital assistants (PDAs), cellular telephones with text messaging functionality, portable email devices, etc. In one embodiment using IMAP, a messaging client 116 identifies a message using a client ID (CID) (the CID is known as the “unique ID” or “UID” in IMAP). The CID uniquely identifies a message only with respect to the messaging client 116 that receives the message, and different clients can use the same CID to identify different messages.

In an embodiment of the system described above, the messaging server 112 receives messages destined for end-users associated with the enterprise. The messaging server 112 stores the message in the message store database 118. The system also causes a copy of the message to be stored at the proxy server 114 closest to the recipient. The messaging clients 116 retrieve messages from the proxy servers 114 rather than the messaging server 112, thereby reducing demand on the messaging server 112. Accordingly, the system allows the administrative convenience of a centralized messaging system, yet reduces processing and bandwidth demands on the central server by distributing messages closer to the messaging clients 116.

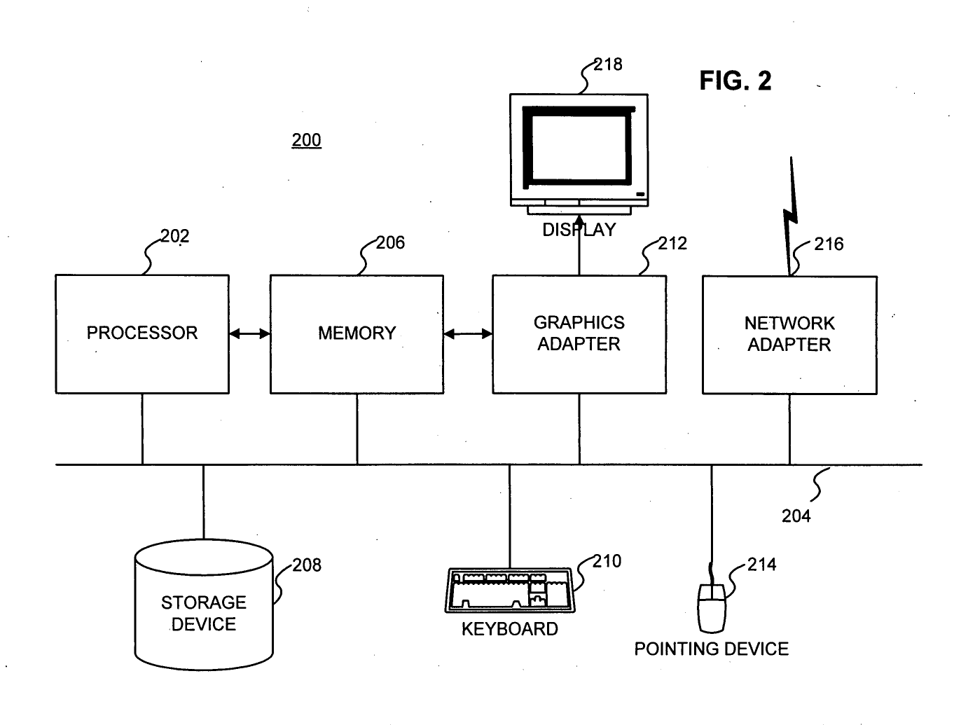

FIG. 2 is a high-level block diagram showing a computer system 200 for acting as a messaging server, proxy server, and/or messaging client according to one embodiment. Illustrated are at least one processor 202 coupled to a bus 204. Also coupled to the bus 204 are a memory 206, a storage device 208, a keyboard 210, a graphics adapter 212, a pointing device 214, and a network adapter 216. A display 218 is coupled to the graphics adapter 212. Computer systems acting in different roles may have different and/or additional elements than the ones shown in FIG. 2. For example, a computer system 200 acting as a messaging server 112 may have greater processing power and a larger storage device than a computer system acting as a messaging client 116. Likewise, a computer system acting as a proxy server 114 may lack devices such as a display 218 and/or keyboard 210 that are not necessarily required to operate the proxy server.

The processor 202 is a general-purpose processor such as an INTEL x86, SUN MICROSYSTEMS SPARC, or POWERPC compatible-CPU. The memory 206 is, for example, firmware, read-only memory (ROM), non-volatile random access memory (NVRAM), and/or RAM, and holds instructions and data used by the processor 202. The pointing device 214 is a mouse, track ball, pressure sensitive pad or other type of pointing device, and is used in combination with the keyboard 210 to input data into the computer system 200. The graphics adapter 212 displays images and other information on the display 218. The network adapter 216 couples the computer system 200 to the network 110. The storage device 208 is a hard disk drive and/or another device capable of storing data, such as a solid-state memory device.

As is known in the art, the computer system 200 is adapted to execute computer program modules. As used herein, the term “module” refers to computer program logic for providing the specified functionality. A module can be implemented in hardware, firmware, and/or software. In one embodiment, the modules are stored on the storage device 208. When utilized, the modules are loaded into the memory 206 and executed by the processor 202.

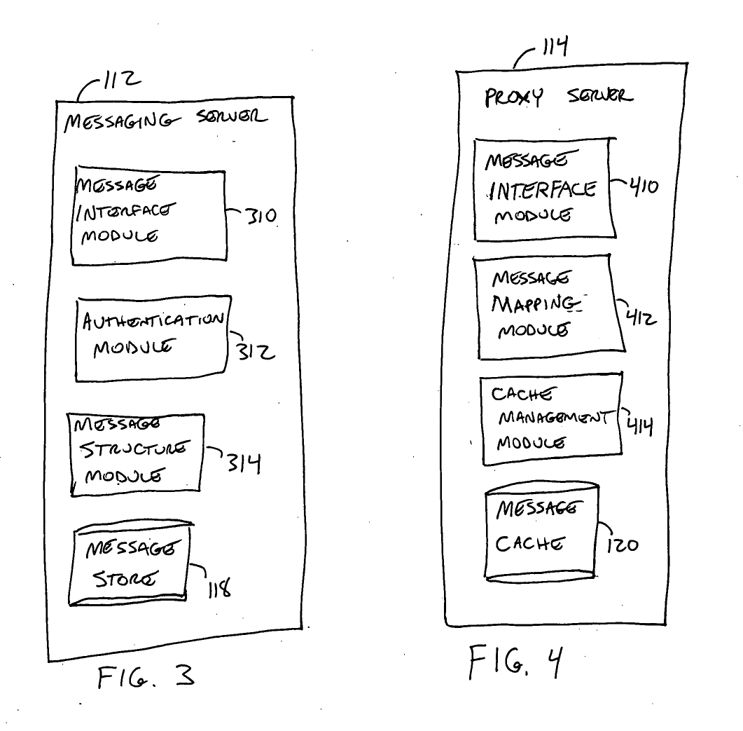

FIG. 3 is a high-level block diagram illustrating modules within the messaging server 112 according to one embodiment. Those of skill in the art will understand that other embodiments of the messaging server 112 and the other entities can have different and/or other modules than the ones described herein. In addition, the functionalities can be distributed among the modules in a manner different than described herein.

In the embodiment of FIG. 3, the messaging server 112 includes a message interface module 310 for exchanging messages with other entities. In one embodiment, the message interface module 310 supports standard protocols for receiving messages from other entities on the network. These message-receiving protocols include, for example, the Simple Mail Transfer Protocol (SMTP), Messaging Application Program Interface (MAPI), and/or Notes Remote Procedure Call (NRPC). In one embodiment, the message interface module 310 supports standard protocols for sending messages to other entities on the network. These message-sending protocols include, for example, the Internet Message Access Protocol (IMAP), Post Office Protocol 3 (POP3), MAPI, and/or NRPC. Through these protocols, the message interface module 310 can send some or all of a message, such as just the header or just the message body.

The messaging server 112 includes an authentication module 312 for authenticating end-users of the messaging system. In one embodiment, the authentication module 312 maintains a login/password pair for each end-user. If an end-user supplies a correct login and password pair, the end-user is granted access to the messages of the end-user having the login. Other embodiments use different authentication schemes.

A message structure module 314 holds structural information related to the end-users' messages. This structural information includes, for example, the end-users' mail folders, folder contents, message flags, and/or control information pertaining to the end-user and/or end-users' messages. In one embodiment, the structural information includes the MID for each message.

FIG. 3 also illustrates the message store database 118. Some or all of the information described above, such as the structural information, is stored in the message store database 118 in one embodiment. In other embodiments, other databases are used to store the information.

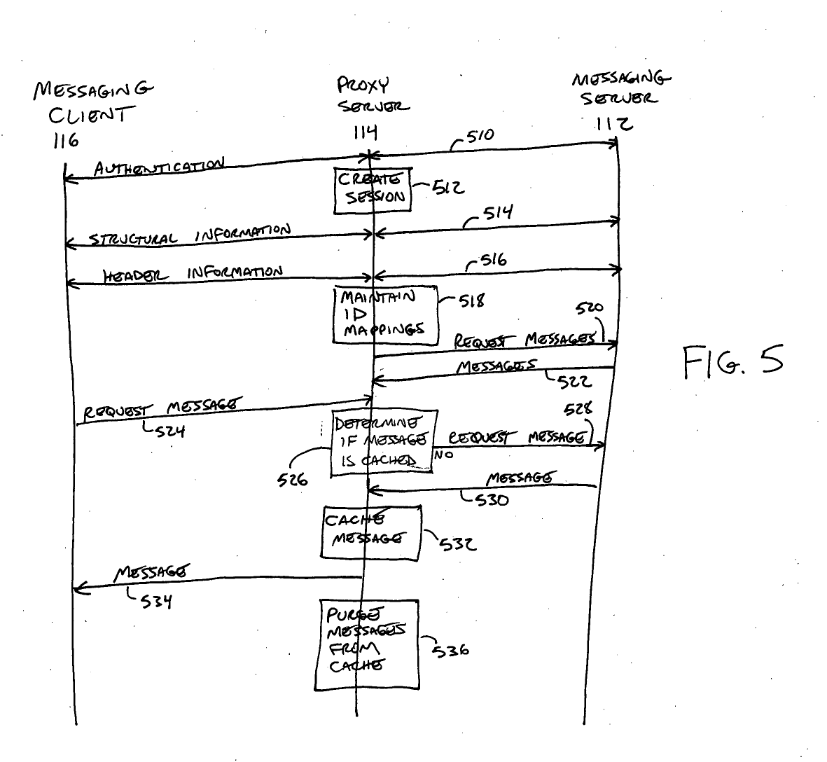

FIG. 4 is a high-level block diagram illustrating modules within the proxy server 114 according to one embodiment. The proxy server 114 includes a message interface module 410 for exchanging messages with other entities. In one embodiment, the message interface module 410 of the proxy server 114 supports the same general functionality as the corresponding module 310 of the messaging server, although the two modules need not be the same. The message interface module 410 stores messages received from the messaging server 112 in the message cache 120 and provides messages stored in the cache to the messaging clients.

In one embodiment, a message mapping module 412 tracks mappings between MIDs used by the messaging server 112 and CIDs used by the messaging clients 116. The message mapping module 412 monitors communications between messaging clients 116 and the messaging server 112 and establishes a state object for each communications session. The message mapping module 412 stores the MID and CID mappings in the state object. Thus, when a client provides a CID, the data in the message mapping module 412 can be used by the message interface module 410 to identify the MID, and message, corresponding to that client's CID.

In one embodiment, a cache management module 414 manages the operation of the message cache 120. The cache management module 414 implements a caching policy according to rules established by an administrator or other entity. The caching policy specifies information such as what types of data are cached, how long data are retained in the cache, and/or whether to proactively obtain data for the cache. In one embodiment, the caching policy can operate the cache 120 in one or more of at least two modes: pull and push. In pull mode, when the proxy server 114 receives a message request from a messaging client 116 it inspects the cache 120 to determine whether it already contains the message. If the cache 120 does not contain the message, the cache obtains the message from the messaging server 112. In push mode, the cache 120 receives some or all messages from the messaging server 112 in advance of requests from the messaging clients 116. Thus, in push mode the cache 120 is likely to already have a message before a client 116 asks for it.

FIG. 5 is a flow diagram illustrating transactions between a messaging client 116, a proxy server 114, and a messaging server 112 according to one embodiment. In the illustration, the three entities are labeled at the top of the figure and are represented by vertical lines descending from the labels. Horizontal lines represent interactions between the entities and text boxes represent actions performed by the entities. In general, time flows from top to bottom in the figure. However, a person of skill in the art will recognize that embodiments of the messaging system can perform the illustrated transactions in orders different than the one shown in FIG. 5. Moreover, other embodiments can include different transactions instead of, or in addition to, the ones described here.

In the interactions of FIG. 5, the proxy server 114 acts as an intermediary between the messaging client 116 and the messaging server 112. The messaging client 116 interacts with the proxy server 114 and the proxy server behaves as if it were the messaging server 114. Likewise, the messaging server 112 interacts with the proxy server 114 and the proxy server behaves as if it were the messaging client 116.

In FIG. 5, the messaging client 116 and the messaging server 112 exchange 510 authentication information in order to authenticate the end-user of the messaging client. The proxy server 114 monitors this transaction and, upon successful authentication, creates 512 a session object for tracking state related to the communications session between the messaging client 116 and messaging server 112. After being authenticated, the messaging client 116 typically requests and receives 514 the structural information from the messaging server 112. The proxy server 114 transparently passes the structural information to the messaging client 116.

In one embodiment, the messaging client 116 requests and receives header information 516. This transaction can occur as part of the structural information transfer and/or as a separate request. The header information includes the headers of any messages sent to the end-user of the messaging client 116 and includes the messages' MIDs. As the header information passes through the proxy server 114, the proxy server 114 generates and assigns CIDs to each message represented by the headers. The proxy server 114 stores 518 the MID to CID mappings.

Depending upon the caching policy implemented by the proxy server 114, in one embodiment the proxy server 114 proactively contacts the messaging server 112 and requests one or more messages associated with end-users of messaging clients 116 in communication with the proxy server 114. The messaging server 112 provides the messages, and the proxy server 114 stores them in its message cache 120.

At some point, the messaging client 116 requests a message 524 from the messaging server 112. The client 116 references this message by its CID. The proxy server 114 receives the message request and uses the mappings to determine the MID of the message. The proxy server 114 determines 526 if the message identified by the MID is stored in the message cache 120. If the message is not cached, the proxy server 114 requests the message 528 from the messaging server 112 and the messaging server provides the message 530. The proxy server 114 caches 532 the received message.

The proxy server 114 provides 534 the cached message to the messaging client 116. In one embodiment, if multiple messaging clients 116 request the same message, the proxy server 114 will provide the cached version of the message rather than obtain a new copy of the message from the messaging server 112. This situation may be encountered, for example, when an email is sent to multiple end-users utilizing the same proxy server 114. The proxy server 114 and cache 120 thus reduce the load on the messaging server 112.

In one embodiment, the caching policy specifies when the proxy server 114 should remove 536 messages from the cache 120. For example, the caching policy can specify removing the messages after a certain time period, after a certain number of other messages have been cached, after a certain aggregate size of messages have been cached, etc.

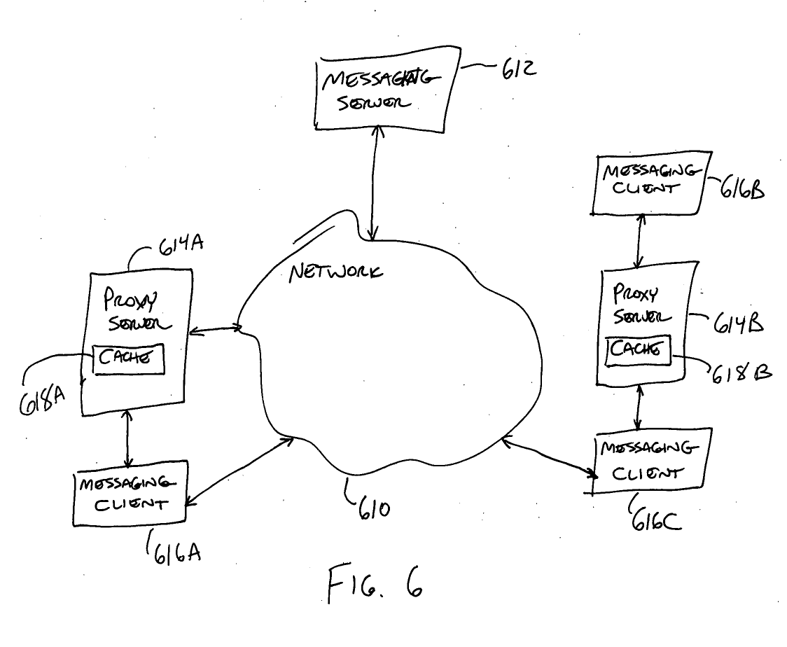

FIG. 6 is a high-level block diagram illustrating an environment 600 including an embodiment of a relational messaging system using caching. The environment 600 of FIG. 6 includes a network 610, messaging server 612, multiple proxy servers 614, and multiple messaging clients 616. End-users of messaging clients 616 use the messaging system to send messages to other end-users. The messages are stored by the messaging. server 612, and components of the messages are stored in caches 618 at the proxy servers. FIG. 6 illustrates the messaging clients 616 directly coupled to the network 610 because in one embodiment the messaging clients directly contact the messaging server 612. However, this difference between FIGS. 1 and 6 does not necessarily mean there are differences in the network structure of the two embodiments.

In the embodiment of FIG. 6, the messaging system shares characteristics with the system described in U.S. patent application Ser. No. 10/789,461, which is incorporated by reference herein. As described in that application, the messaging system uses a relational model to represent and store messages exchanged among the end-users. Thus, the system of FIG. 6 is referred to as a “relational messaging system.”

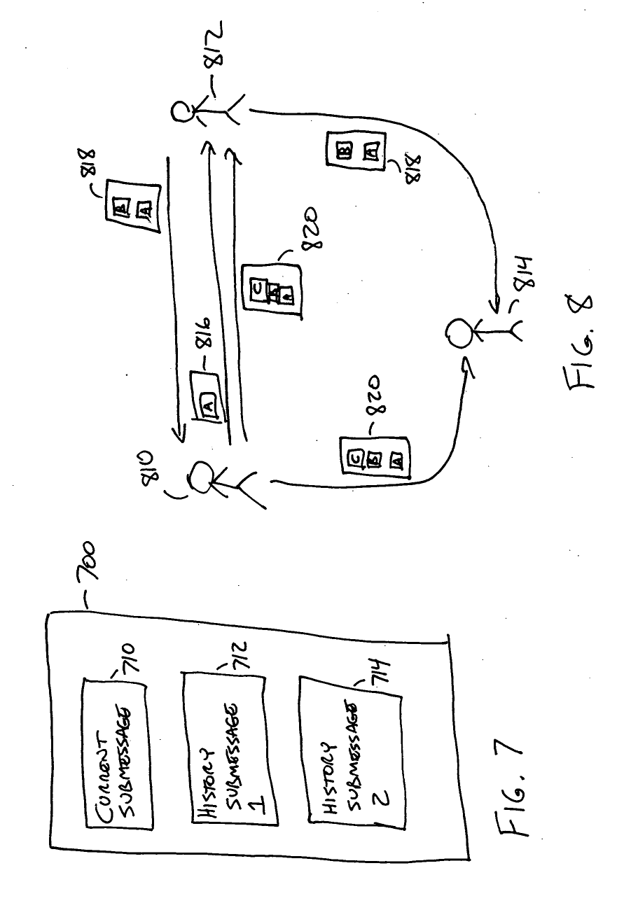

FIG. 7 is a block diagram illustrating a representation of a message 700 exchanged according to an embodiment of the relational messaging system. In this embodiment, a message can be thought of as a container with relational links. The container itself does not contain content, but rather points to submessages and/or attachments in which content resides. When an end-user composes and sends a message, she is actually composing a submessage, and then sending a message 700 containing a reference to the submessage 700 to other end-users. The submessage composed and sent by the end-user is called the “current submessage.” Any submessages that were previously in the message are called “history submessages.” For example, if an end-user receives a message containing one submessage, at the time of receipt the single submessage is the current submessage. When the end-user composes and sends a reply, the submessage containing the reply becomes the current submessage, and the other submessage becomes a history submessage. The end-user can also associate one or more attachments with a submessage. In one embodiment, the attachments are relationally linked within a message in the same manner as submessages. Thus, attachments can be treated in the same manner as submessages and descriptions of submessages contained herein are equally applicable to attachments. The exemplary message 700 of FIG. 7 contains one current submessage 710 and two history submessages 712, 714 representing previously sent submessages within the message 700.

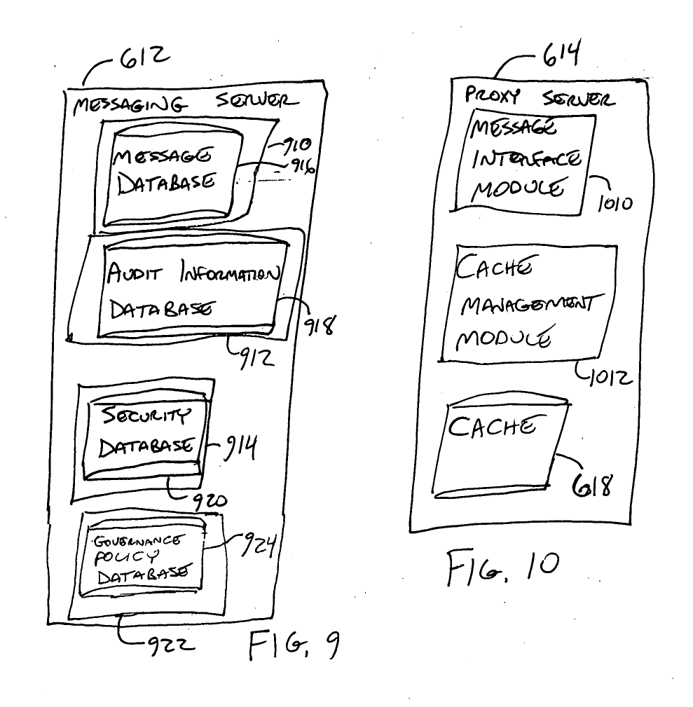

FIG. 8 illustrates a set of interactions that explain the relationship among messages 700, current submessages 710, and history submessages 712, 714. The figure illustrates three people, Alice 810, John 812, and Peter 814. Initially, Alice 810 composes a message 816 containing submessage A and sends it to John 812. John 812 replies 818 and also copies the message to Peter 814. In the reply 818, submessage B is the current submessage and submessage A becomes a history submessage. Next, Alice 810 replies to both John 812 and Peter 814 and sends a third version 820 of the message having a new current submessage C, and two history submessages B and C.

FIG. 9 is a high-level block diagram illustrating modules within the messaging server 612 according to one embodiment of the relational messaging system. In the illustrated embodiment, the messaging server includes a messaging module 910, an auditing module 912, a security module 914, and a governance module 922. These modules respectively contain a message database 916, an audit information database 918, a security database 920, and a governance policy database 924. Although separate modules and databases are illustrated in FIG. 9, in some embodiments these elements are combined and/or distributed in different manners than shown. In one embodiment the messaging server 612 also includes modules illustrated within the messaging server of FIG. 3, such as a message interface module 310 and/or authentication module 312 adapted to interact in the relational messaging system.

The message module 910 controls the message database 916. This database 916 stores data related to the messages exchanged using the relational messaging system. These data include the messages, submessages, and attachments and are stored as logically discrete components, meaning that each message, submessage and attachment can be accessed separately. In one embodiment, the message database 916 associates a unique ID with each message, submessage, and attachment. These IDs are utilized throughout the messaging system.

The auditing module 912 controls the audit information database 918. This database 918 stores audit information for the relational messaging system. The audit information describes the usage of the messaging system; including a transaction history of the messages, submessages, and attachments. Audit information thus can include data such as which end-users composed which messages/submessages, which users read which messages, which users replied to and/or forwarded which messages, etc. The audit information can also describe characteristics of the messages, submessages, and attachments such as sensitivity levels for particular components (e.g., whether a submessage is secured, cacheable, forwardable, etc.), whether the components can be viewed by particular people, etc. The audit information is distinct from the messages, submessages, and attachments and in one embodiment is managed separately.

In one embodiment, some or all of the information in the message database 916 is secured to prohibit unauthorized access. The security module 914 manages access to secured messages, submessages, and/or attachments and allows end-users to view only messages for which they are authorized. As part of this role, the security module 914 controls the security database 920. This database 920 stores security information for the relational messaging system.

In one embodiment, the security database 920 stores keys utilize to encrypt messages, submessages, and/or attachments provided to the proxy servers 614. In one embodiment, each secured message component is encrypted with a different synchronous key using the Advanced Encryption Standard (AES). The typical key length varies from 128 bits to 4096 bits, depending upon the enterprise's security policy. The key is associated with the secured component, as opposed to being associated with an end-user and/or messaging client 116. Thus, the security module 914 can grant a messaging client 616 access to a secured component by providing the client with the component's key. Other embodiments use different types of security schemes, keys and/or key lengths to encrypt and decrypt message components.

The governance module 922 controls the governance policy database 924. This database 924 stores governance policies for use by the messaging clients 616 and/or other entities in the messaging system. A governance policy includes one or more governance rules that describe the behaviors, rights, and/or privileges of the messaging client 616 and/or other entity for which the policy is applicable. For example, the governance policy can describe whether the messaging client 616 can cache submessages, attachments, and/or security information. Likewise, the governance policy can specify whether an end-user can view cached content while the messaging client 616 is offline.

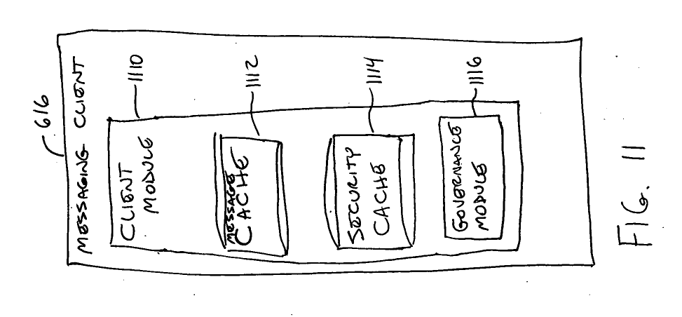

FIG. 10 is a high-level block diagram illustrating modules within the proxy server 614 according to one embodiment of the relational messaging system. The proxy server 614 includes a message interface module 1010 for exchanging submessages and/or attachments with the messaging server 612 and messaging clients 616.

In one embodiment, the proxy server 614 includes a cache management module 1012 that manages the operation of the proxy's cache 618. The cache management module 1012 implements a caching policy according to rules established by an administrator or other entity. The caching policy can operate the cache in pull and/or push mode, as described above. When the proxy server 614 receives a request for a submessage and/or attachment from a messaging client 616, the proxy server 614 seeks to fulfill the request using a copy stored in the cache 618.

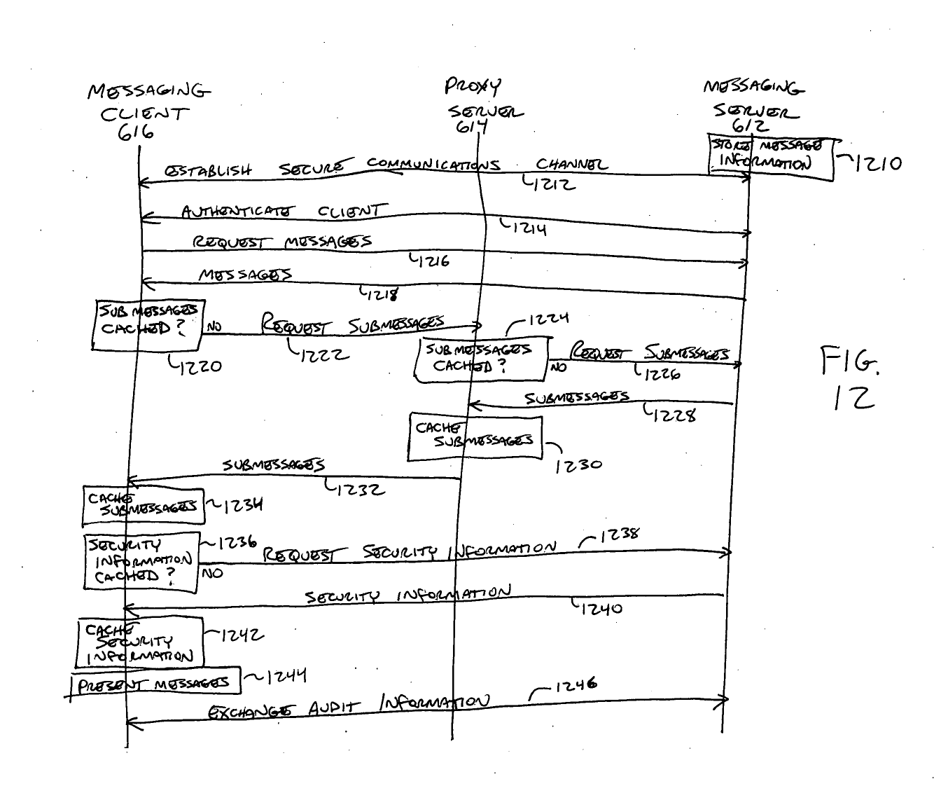

FIG. 11 is a high-level block diagram illustrating modules within the messaging client 616 according to one embodiment of the relational messaging system. The messaging client 616 includes a client module 1110 adapted to utilize the relational messaging system. In one embodiment, the client module 1110 is an application dedicated to sending and receiving messages over the relational messaging system. As such, it includes standard functionality for composing messages, viewing messages, replying to and forwarding messages, etc. In another embodiment, the client module 1110 operates in tandem with another module, such as a web browser or email application to provide integrated relational messaging functionality.

In one embodiment, the client module 1110 includes a message cache 1112 for caching submessages and/or attachments received by the client module 1110. The client module 1110 also includes a security cache 1114 for caching security information retrieved from the security database 622 at the messaging server 612. The client module 1110 utilizes the security information in the security cache 1114 to access secured submessages and/or attachments stored in the message cache 1112. The client module 1110 manages both of these caches 1112, 1114 according to a caching policy.

In one embodiment, the client module 1110 includes a governance module 1116 for storing one or more governance policies received from the messaging server 612. The governance module 1116 applies the governance policies to the messaging client 616.

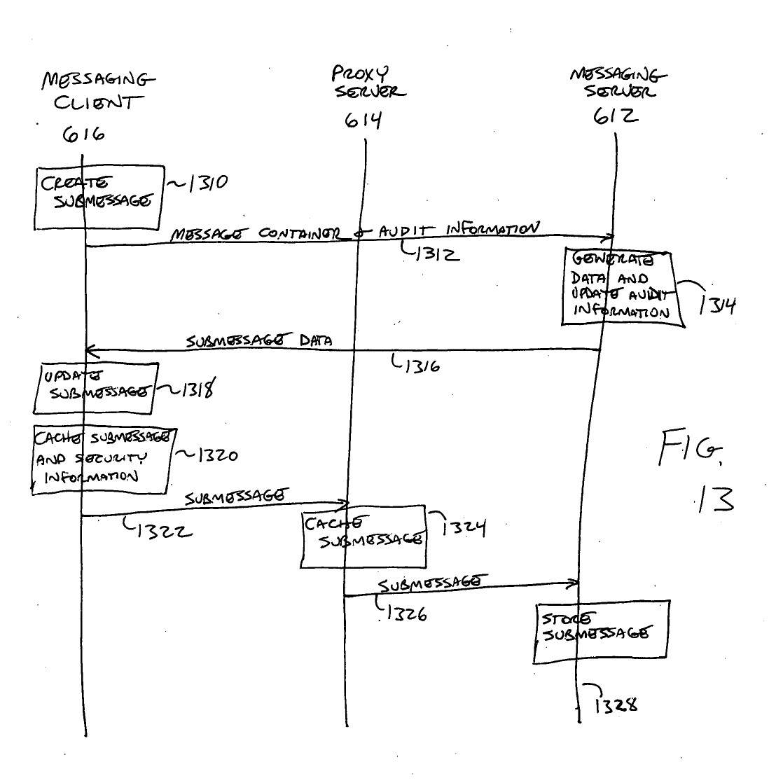

FIG. 12 is a flow diagram illustrating transactions between a messaging client 616, a proxy server 614, and a messaging server 612 according to one embodiment. FIG. 12 illustrates a specific set of transactions that occur when an end-user of a client 616 is accessing and reading messages. A person of skill in the art will recognize that embodiments of the messaging system can perform the illustrated transactions in orders different than the one shown in FIG. 12. Moreover, other embodiments can include different transactions instead of, or in addition to, the ones described here.

Assume for purposes of this discussion that the messaging server 612 was in use prior to the transactions illustrated in FIG. 12. As part of this use, the messaging server 612 has stored 1210 multiple messages, including some messages created by and sent to the end-user of the messaging client 616. In addition, the messaging server 612 stores security and audit information for the messages.

The messaging client 616 and the messaging server 612 establish 1212 a secure communications channel over the network 610. In one embodiment, the channel is opened using SSL or another protocol that allows the client 616 and server 612 to engage in encrypted communications. The messaging client 616 and messaging server 612 exchange 1214 authentication information over the secure channel in order to authenticate 912 the end-user of the messaging client.

Once the end-user is authenticated, the messaging client 616 requests 1216 the end-user's messages from the messaging server 612. In response, the messaging server 612 sends 1218 one or more message containers to the client 616. The messages do not include any content. Rather, the messages include links to submessages and any attachments.

Upon receiving the message containers from the messaging server 612, the messaging client 616 retrieves the submessages referenced therein. In one embodiment, the messaging client 616 queries 1220 its local submessage cache 628 for the submessages. If some or all of the submessages are not cached locally, the messaging client 616 requests 1222 the submessages from the proxy server 614. The proxy server 614 determines 1224 whether the submessages are in its cache 618. If the submessages are not cached, the proxy server 614 obtains 1226, 1228 the submessages from the messaging server. 612 and stores 1230 them in its cache 618. If the submessages are cached at the proxy server 614, or after the submessages are retrieved from the messaging server 612, the proxy server sends 1232 the cached submessages to the messaging client 616. The messaging client may cache 1234 the submessages upon receipt. The same retrieval process can also be performed for attachments.

In an embodiment where the submessages are secured, the messaging client 616 must obtain the security information for the submessages before it can present the messages in a comprehensible format. In one embodiment, the messaging client 616 queries 1236 its local security cache 630 for the security information. If some or all of the security information is not cached locally, the messaging client 616 obtains 1238, 1240 the security information from the messaging server 612 and stores 1242 it in its local cache. The messaging client 616 can obtain security information for attachments in the same manner.

In the embodiment described here, the security information necessary to access the submessages and/or attachments is not stored or otherwise available to the proxy server 614. As a result, a malicious agent or other third party that compromises the proxy server 614 cannot access the submessages. This arrangement thus maintains the security of the messaging system while allowing the submessages and/or attachments to be distributed near the messaging clients 616 on relatively unsecured proxy servers 614. In one embodiment, the messaging client 616 similarly does not cache the security information. In alternative embodiments, security information is cached at the proxy server 614.

The messaging client 616 uses the security information to decrypt the submessages and/or attachments. Then, the messaging client 616 presents 1244 the messages to the end-user. The messaging client 616 also exchanges 1246 the audit information with the messaging server 612. The audit information exchange 1246 can also occur at other points in the flow shown in FIG. 9. In one embodiment, audit information changes frequently during the operation of the messaging system and there are regular audit information exchanges between the messaging client 616 and the messaging server 612.

FIG. 13 is a flow diagram illustrating transactions between a messaging client 616, a proxy server 614, and a messaging server 612 according to one embodiment. FIG. 13 illustrates a specific set of transactions that occur when an end-user of a client 616 creates and sends a submessage. A person of skill in the art will recognize that embodiments of the messaging system can perform the illustrated transactions in orders different than the one shown in FIG. 13. Moreover, other embodiments can include different transactions instead of, or in addition to, the ones described here.

The end-user uses the messaging client 616 to create 1310 a new submessage. In one embodiment, the end-user creates 1310 a new submessage and message by pressing a “new” button on a graphical user interface or performing another equivalent action. Similarly, the end-user can create a new submessage by replying to or forwarding an existing message. The end-user provides content for the submessage and associates zero or more attachments with it. As part of the messaging process, the end-user also specifies audit information associated with the submessage and/or message. The audit information can include, for example, the creator and the recipients of the message and/or submessage.

In one embodiment, the messaging client 616 contacts the messaging server 612 and provides 1312 it with the message container and associated audit information indicating that a new submessage has been created. The messaging server 612 generates 1314 an ID for the submessage and, if necessary, for the message. The messaging server 612 stores the ID and associated audit information in the message 916 and audit information 918 databases, respectively. The messaging server 612 also generates the security information for the submessage and stores it in the security database 920. The messaging server 612 provides 1316 the ID, security information and/or any updated audit information to the messaging client 616. In an alternative embodiment, the messaging client 616 generates the ID and/or security information locally and provides the information to the messaging server.

The messaging client 616 assigns 1318 the ID received from the messaging server 612 to the submessage. The messaging client 616 secures 1318 the submessage using the security information received from the messaging server 612 and stores 1320 the secured submessage and security information in the message 1112 and security 1114 caches, respectively. The messaging client 616 also provides 1322 the secured submessage to the proxy server 614. The proxy server 614 caches 1324 the submessage and also provides 1326 a copy of it to the messaging server 612. The messaging server 612 stores 1328 the submessage in the message database 618.

In sum, the messaging systems described herein provide the benefits of a centralized messaging system but uses caching to eliminate the drawbacks traditionally found in such systems. The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

1. A computer-implemented method of delivering electronic messages, comprising:
providing a messaging client with information identifying electronic messages available to the messaging client;
caching copies of the electronic messages close to the messaging client; and
responsive to a request from the messaging client for the identified electronic messages, providing the cached copies of the electronic messages to the messaging client.

2. The method of claim 1, further comprising:
securing the electronic messages using security information, wherein the secured messages are cached close to the messaging client; and
responsive to a request from the messaging client, providing the security information for the secured messages to the messaging client.

3. The computer implemented method of claim 1, wherein the information identifying electronic messages comprises a message container having relational links to submessages, copies of the submessages are cached close to the messaging client, and the cached copies of the submessages are provided to the messaging client responsive to the request.

4. The computer implemented method of claim 1, further comprising:
providing the messaging client with audit information describing transaction histories of the electronic messages provided to the messaging client.

5. The method of claim 1, further comprising:
creating a mapping of client identifiers, used by the messaging client to identify electronic messages destined for the messaging client, to message identifiers utilized by a messaging server to identify the electronic messages destined for the messaging client; and
responsive to receiving a request from the messaging client for an electronic message identified with a client identifier, determining the message identifier for the electronic message.

6. The method of claim 1, wherein caching copies of the electronic messages occurs responsive to receiving the request from the messaging client for the identified electronic messages.

7. The method of claim 1, wherein caching copies of the electronic message occurs prior to receiving the request from the messaging client for the identified electronic message.

8. The method of claim 1, wherein the electronic messages are emails and wherein the messaging client requests the emails using one or more email protocols from the group consisting of:
the Simple Mail Transfer Protocol (SMTP), the Messaging Application Program Interface (MAPI), the Notes Remote Procedure Call (NRPC), the Internet Message Access Protocol (IMAP), and the Post Office Protocol 3 (POP3).

9. A computer system adapted for use in a messaging system, comprising:
a cache management module for managing a cache, the cache storing messages exchanged by the messaging system; and
an interface module for interfacing with a messaging client and a messaging server, the interface module adapted to receive messages from the server and provide messages to the client, wherein messages received from the server are stored in the cache and messages provided to the client are provided from the cache.

10. The computer system of claim 9, wherein the messaging client uses client identifiers to identify message exchanged by the messaging system and wherein the messaging server uses message identifiers to identify the messages, further comprising:
a message mapping module for maintaining mappings between the client identifiers and the message server identifiers,
wherein the cache identifies messages using the message identifiers and the messaging module is adapted to receive a client identifier from a messaging client and utilize the mapping to identify a corresponding message in the cache.

11. The computer system of claim 10, wherein the message mapping module is adapted to monitor a communications session between the messaging client and the messaging server and track message and client identifier mappings for the session.

12. The computer system of claim 9, wherein a message is an email and wherein the interface module supports one or more email protocols from the group consisting of:
the Simple Mail Transfer Protocol (SMTP), the Messaging Application Program Interface (MAPI), the Notes Remote Procedure Call (NRPC), the Internet Message Access Protocol (IMAP), and the Post Office Protocol 3 (POP3).

13. The computer system of claim 9, wherein the messaging system is a relational messaging system, messages are comprised of submessages, and the cache management module stores the submessages in the cache.

14. A messaging server in a relational messaging system, comprising:
a messaging module for controlling a message database storing messages exchanged in the relational messaging system, each message comprising one or more submessages;
a security module for controlling a security database storing security information for the submessages in the message database; and
an interface module for interacting with a messaging client and a proxy server, the interface module adapted to provide the security information to the messaging client and the submessages to the proxy server,
wherein the proxy server is adapted to cache the submessages and,
wherein the messaging client is adapted to retrieve the cached submessages from the proxy server and access the submessages using the security information.

15. The messaging server of claim 14, further comprising:
an auditing module for controlling an audit information database storing audit information describing usage of the relational messaging system,
wherein the interface module is adapted to provide the audit information to the messaging client and receive audit information from the messaging client and store it in the audit information database.

16. The messaging server of claim 14, wherein a message in the message database comprises:
a message container containing relational links to one or more submessages and wherein the interface module is adapted to provide the message container to the messaging client.

17. The messaging server of claim 14, wherein a message in the message database comprises:
a current submessage specifying a most recent submessage in the message; and
a history submessage specifying a previous current submessage.

18. The messaging server of claim 14, wherein at least some of the submessages in the message database are encrypted and wherein the security database stores keys for decrypting the submessages.

19. The messaging server of claim 14, further comprising:
a governance module for controlling a governance policy database storing governance policies describing rights of the messaging client,
wherein the interface module is adapted to provide the governance policy to the messaging client.

20. A computer program product having a computer-readable medium having embodied thereon program code for use in a messaging system, comprising:
a cache management module for managing a cache, the cache storing messages exchanged by the messaging system; and
an interface module for interfacing with a messaging client and a messaging server, the interface module adapted to receive messages from the server and provide messages to the client, wherein messages received from the server are stored in the cache and messages provided to the client are provided from the cache.

21. The computer program product of claim 20, wherein the messaging client uses client identifiers to identify message exchanged by the messaging system and wherein the messaging server uses message identifiers to identify the messages, further comprising:
a message mapping module for maintaining mappings between the client identifiers and the message identifiers,
wherein the cache identifies messages using the message identifiers and the messaging module is adapted to receive a client identifier from a messaging client and utilize the mapping to identify a corresponding message in the cache.

22. The computer program product of claim 21, wherein the message mapping module is adapted to monitor a communications session between the messaging client and the messaging server and track message and client identifier mappings for the session.

23. The computer program product of claim 20, wherein a message is an email and wherein the interface module supports one or more email protocols from the group consisting of:
the Simple Mail Transfer Protocol (SMTP), the Messaging Application Program Interface (MAPI), the Notes Remote Procedure Call (NRPC), the Internet Message Access Protocol (IMAP), and the Post Office Protocol 3 (POP3).

24. The computer program product of claim 20 wherein the messaging system is a relational messaging system, messages are comprised of submessages, and the cache management module stores the submessages in the cache.

25. A computer program product having a computer-readable medium having embodied thereon program code for use in a relational messaging system, comprising:
a messaging module for controlling a message database storing messages exchanged in the relational messaging system, each message comprising one or more submessages;
a security module for controlling a security database storing security information for the submessages in the message database; and
an interface module for interacting with a messaging client and a proxy server, the interface module adapted to provide the security information to the messaging client and the submessages to the proxy server,
wherein the proxy server is adapted to cache the submessages and,
wherein the messaging client is adapted to retrieve the cached submessages from the proxy server and access the submessages using the security information.

26. The computer program product of claim 25, further comprising:
an auditing module for controlling an audit information database storing audit information describing usage of the relational messaging system,
wherein the interface module is adapted to provide the audit information to the messaging client and receive audit information from the messaging client and store it in the audit information database.

27. The computer program product of claim 25, wherein a message in the message database comprises:
a message container containing relational links to one or more submessages and wherein the interface module is adapted to provide the message container to the messaging client.

28. The computer program product of claim 25, wherein a message in the message database comprises:
a current submessage specifying a most recent submessage in the message; and
a history submessage specifying a previous current submessage.

29. The computer program product of claim 25, wherein at least some of the submessages in the message database are encrypted and wherein the security database stores keys for decrypting the submessages.

30. The computer program product of claim 25, further comprising:
a governance module for controlling a governance policy database storing governance policies describing rights of the messaging client,
wherein the interface module is adapted to provide the governance policy to the messaging client.

31. A relational messaging system for exchanging messages with a messaging client, comprising:
a messaging server for storing messages exchanged in the relational messaging system, each message comprising a container having links to one or more submessages and for providing the container to the messaging client; and
a proxy server for caching submessages received from the messaging server and for providing the cached submessages to the messaging client.

32. The relational messaging system of claim 31, wherein submessages stored by the messaging server are secured and wherein the messaging server further comprises:
a security module for controlling a security database storing security information for the submessages in the message database; and
an interface module for providing the security information to the messaging client to allow the messaging client to access the submessages.

33. The relational messaging system of claim 31, further comprising:
an auditing module for controlling an audit information database storing audit information describing usage of the relational messaging system,
wherein the interface module is adapted to provide the audit information to the messaging client and receive audit information from the messaging client and store it in the audit information database.

34. The relational messaging system of claim 31, wherein the proxy server comprises:
a cache management module for retrieving submessages destined for the messaging client from the messaging server prior to receiving a request from the messaging client for the submessages.

35. The relational messaging system of claim 31, wherein the proxy server comprises:
a cache management module for retrieving submessages destined for the messaging client from the messaging server responsive to receiving a request from the messaging client for the messages.
